(19) United States
(12) Patent Application Publication
(10) Pub. No.: US 2020/0300007 A1
(43) Pub. Date: Sep. 24, 2020

(54) Metal Ware for a Window

(71) Applicant: CAPOFERRI SERRAMENTI S.P.A., Adrara San Martino BG (IT)

(72) Inventor: Sergio CAPOFERRI, ADRARA San MARTINO (BERGAMO) (IT)

(73) Assignee: CAPOFERRI SERRAMENTI S.P.A., Adrara San Martino BG (IT)

(21) Appl. No.: 16/754,979

(22) PCT Filed: Oct. 8, 2018
(86) PCT No.: PCT/IB2018/057771

§ 371 Date: Apr. 9, 2020

(30) Foreign Application Priority Data
Oct. 12, 2017 (IT) 102017000115099

(51) Int. Cl. E05C 9/00; E05C 9/02; E05B 63/00

(52) U.S. Cl. CPC E05C 9/006; E05C 9/021; E05Y 2900/148; E05C 9/004; E05B 63/0021

(57) ABSTRACT

A window metalware comprising: a strip, a rod, locking members, a rack, and a pinion. The strip is mounted on the window strut. The rod, slidably mounted on the strip, has an outer surface and an inner surface. The locking members are firmly mounted on the rod. The rack is firmly mounted on the rod. The pinion is rotatably mounted on the strip to engage the rack. The axis X of the pinion is fixed on the strip, and the rod is between the strip and the pinion. The pitch surface of the rack is spaced, with respect to the inner surface of the rod, towards the strip, beyond the half thickness of the rod. The rod comprises an aperture inside which a canal-shaped structure is inserted and the rack is placed in the canal-shaped structure.

The present invention relates to the metalware for a window, in particular the set of accessories, usually metallic, which are applied to the window frame to allow its opening and closure.

The term window will refer to the windows as such, but also more generally to French windows, doors, skylights, and the like.

The technical features of the window are described below with reference to the configuration that it most commonly assumes, that is, the configuration in which it is arranged vertically.

In a widely known manner, the window comprises a fixed frame, a movable frame and a handle which facilitates movement of the movable frame during opening and closure. The fixed frame develops mainly in a vertical plane. In a known manner, the handle also controls window locking members which allow the movable frame (or shutter) to be locked in the closure position. The window locking members may comprise one or more latches, usually movable along the vertical direction. Each latch, protruding from the movable frame shape, engages a respective seat obtained by means of a hole in the fixed frame. In addition, or alternatively to the latches, the window locking members may also comprise one or more locking pins. Also, the locking pins are usually movable along the vertical direction, but unlike the latches they do not protrude from the movable frame shape. The locking pins run along a strut of the movable frame and are designed to engage suitable U-shaped seats formed on the frame (fixed or mobile in turn) to which the shutter matches when it is brought into the closure position.

The windows that allow two different types of opening are particularly widespread and appreciated. A first type of opening, called a swing opening, is that in which the shutter is free to rotate around the main hinge axis (usually vertical and placed laterally to the movable frame). This movement allows to open the window completely, for example to let a large amount of air pass through. This opening allows at the same time the passage through the window of voluminous objects or of people, possibly even unwanted. Moreover, unless auxiliary closure devices are provided external with respect to the window, this type of opening leaves the shutter free to move independently with respect to the user's will, typically following the air drafts. A second type of opening is that which instead allows the shutter a limited movement and which, once the opening limit has been reached, keeps it almost steady in position. Usually this type of opening is called fanlight or tilt opening and is obtained by rotating the shutter around a secondary hinge axis (horizontal and located below the movable frame). This second type of opening allows the passage of a reduced amount of air, does not allow the passage of people at all and prevents the shutter from moving in an unwanted way.

In order to control the window locking members, the handle can rotate around an axis perpendicular to the movable frame plane, so as to take different positions. Usually the handle comprises a lever which can rotate between three positions: a closure position, a swing opening position and a fanlight opening position.

Generally, the locking position of the shutter is obtained with the handle vertically, for example with the lever facing downwards. By turning the handle 90°, and then bringing it horizontally, it usually moves into the swing opening position. By further turning the handle another 90°, and then bringing it vertically again but with the lever facing upwards, it moves into the fanlight opening position. Within an overall rotation of 180° the handle must therefore be able to provide a sufficient stroke for moving the window locking members so that they move from one to the other of the three configurations. Generally, it is considered that it is not appropriate to allow the handle a rotation angle greater than 180°. In this way, in fact, the handle lever would exit from the outer shape of the movable frame, constituting an obstruction for the movement of the shutter itself.

The window metalware of the known type further comprises a strip and a rod which support the window locking members and the handle. The strip is fixed to the thickness of the free strut of the movable frame. Below the fixed strip, in a dedicated channel, the rod is housed which is free to slide along the strut of the movable frame. A latch can be mounted at the end of the rod. In addition, slots are provided along the fixed strip through which the locking pins mounted on the underlying rod protrude.

The handle is also mounted at an intermediate point of the strip. The handle comprises a pinion that engages a rack fixed on the rod. The handle rotation therefore determines the pinion rotation and thus the translation of the rack and of the rod fixed thereto. The translation of the rod determines an identical translation of the latch and/or of the locking pins, a translation necessary to move from the locking position of the shutter to the opening position.

From the foregoing, the skilled person can easily understand how the maximum translation that can be obtained for the window locking members is limited by the pitch radius of the pinion. In fact, the overall rotation of the handle being fixed in just 180°, the maximum translation obtainable for the rod along which to place the three positions (locking, swing opening, fanlight opening) is equal to the pitch radius of the pinion multiplied by π.

In turn, however, the pinion dimensions, and therefore its pitch radius, are not free from constraints at all. In particular, it is commonly believed that the window structures (i.e. the fixed frame and the movable frame) must be as thin as possible in order to favour the glazed surface. From this constraint derives that the reduced dimensions of the strut which houses the handle and the window locking members limit the pinion radius in cascade and therefore the maximum stroke of the rod.

However, the windows and the related window locking members described so far, although widely appreciated, are not free from defects.

In fact, as the skilled person can well understand, the size of the locking pins and the useful stroke of the latch are limited by the stroke of the rod obtained with 90° rotation of the handle. In the locked position each of the locking pins must be housed inside the respective U-shaped seat, while the latch must sink as far as possible into the respective hole seat. On the contrary, the locking pins in the opening position must be completely outside the respective U-shaped seats and the latch must be completely outside the respective hole seat. The maximum diameter of the locking pins is therefore limited by the stroke which can be obtained with a 90° rotation of the handle, and this stroke is in turn limited by the strut dimensions of the movable frame. From this derives that the locking pins have a limited mechanical resistance and, with the closing of the window, guarantee a limited level of safety.

Therefore, the object of the present invention is to overcome the drawbacks pointed out above with respect to the prior art.

In particular, a task of the present invention is to provide a metalware for a window which can combine the need to maintain reduced dimensions for the movable frame strut and, at the same time, allow larger dimensions for the locking pins.

In this way, the metalware for a window allows to obtain locking pins with greater mechanical resistance and therefore to increase the level of safety. Furthermore, a task of the present invention is to provide a metalware for a window which, alongside the advantages introduced with respect to the known solutions, also maintains their benefits.

This object and these tasks are achieved by means of a window metalware according to claim 1, and by means of a window according to claim 7.

To better understand the invention and appreciate its advantages, some of its exemplifying and non-limiting embodiments are described below with reference to the accompanying drawings, wherein:

FIG. 1 schematically shows a first type of prior art window in a closed configuration;

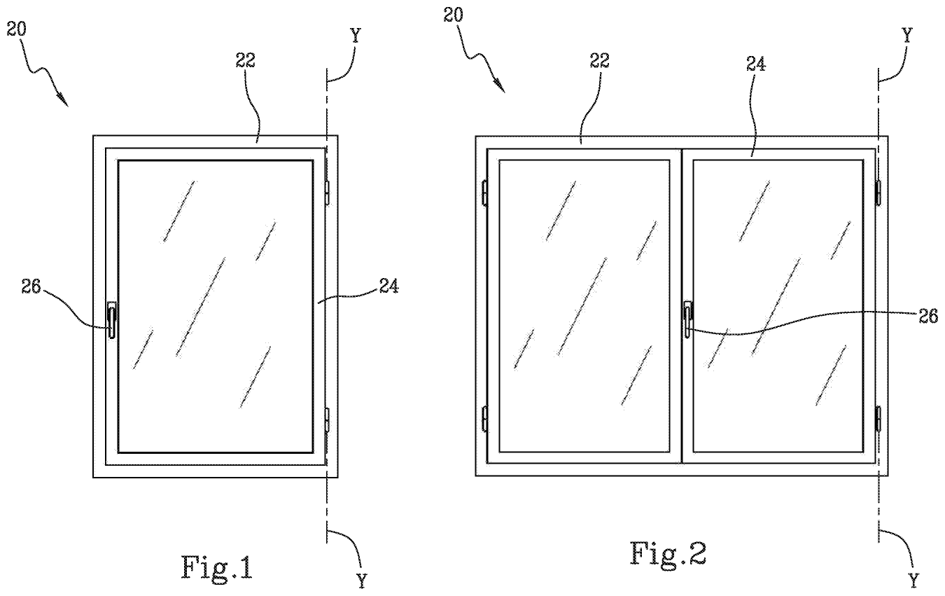

FIG. 2 schematically shows a second type of prior art window in a closed configuration;

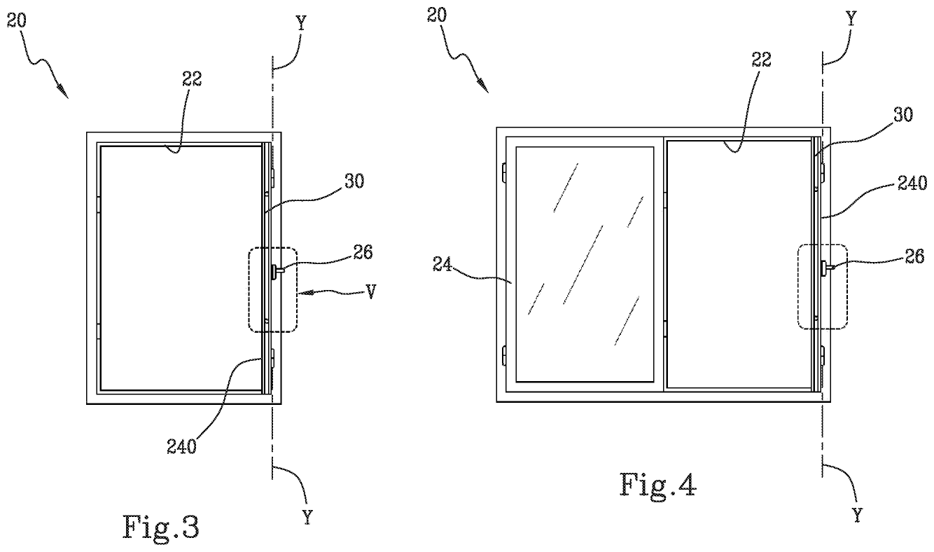

FIG. 3 schematically shows the window of FIG. 1 in an open configuration;

FIG. 4 schematically shows the window of FIG. 2 in an open configuration;

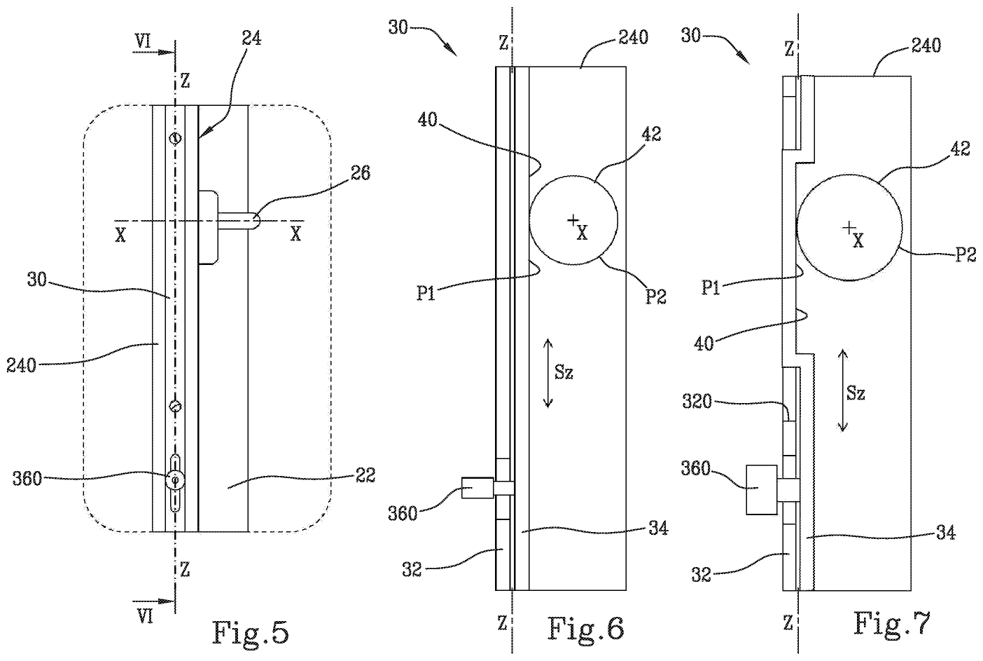

FIG. 5 schematically shows an enlarged view of the detail referred to as V in FIGS. 3 and 4;

FIG. 6 schematically shows a view of the cross section made along the plane VI-VI of FIG. 5;

FIG. 7 schematically shows the view of a cross section similar to that of FIG. 6, made on a window according to the invention;

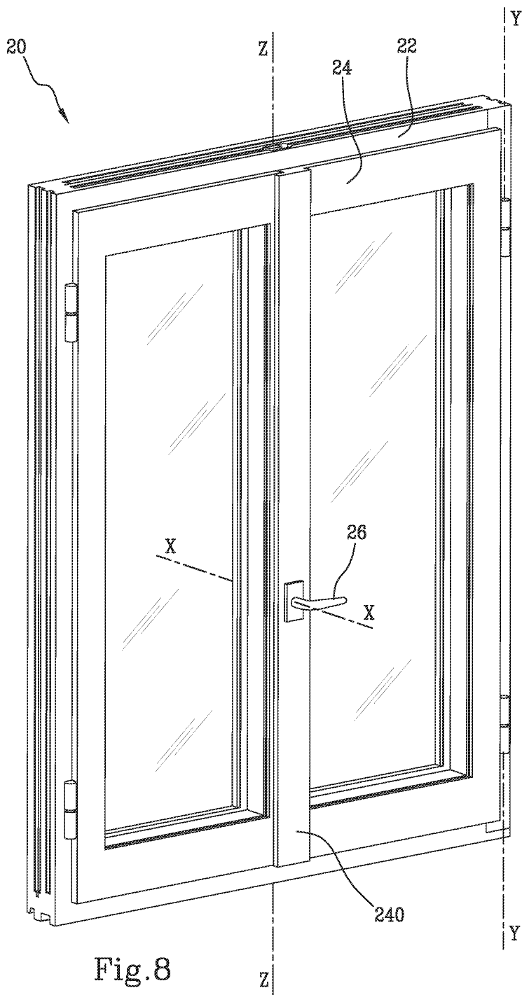

FIG. 8 shows a perspective view of a window according to the invention, in a closed configuration;

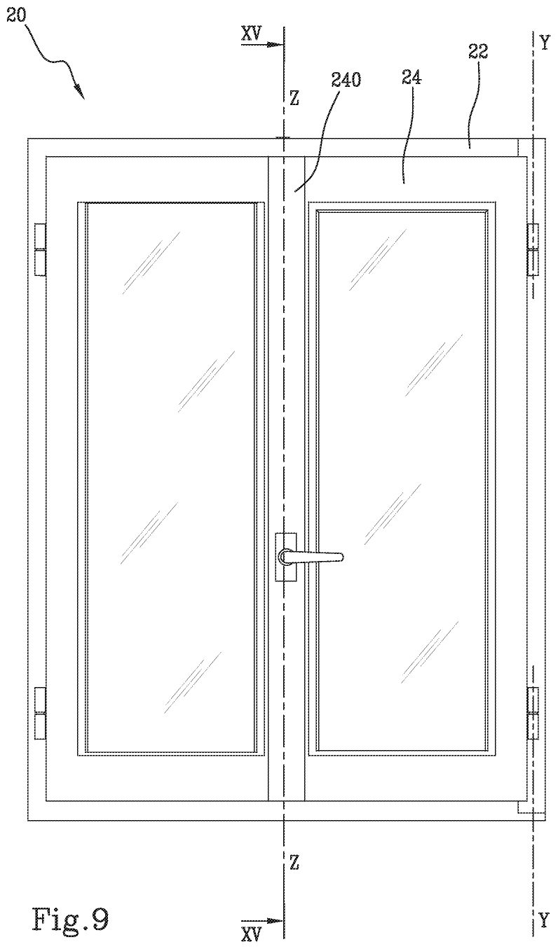

FIG. 9 shows a front view of the window of FIG. 8;

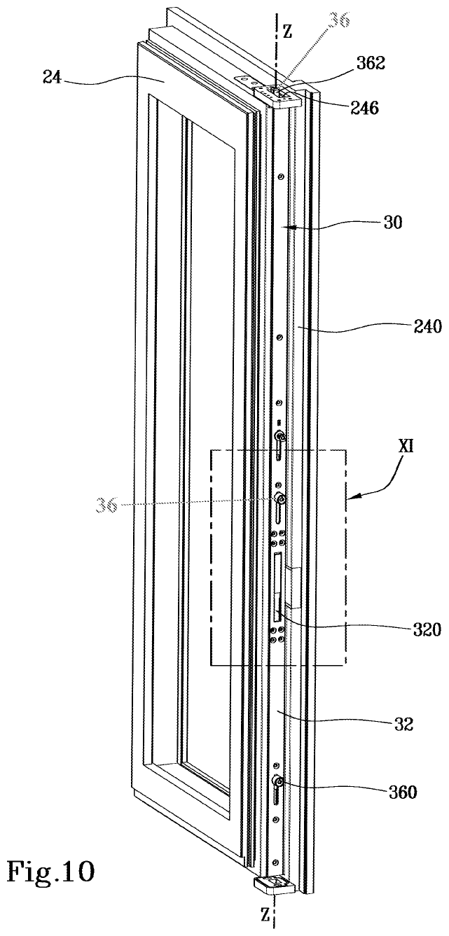

FIG. 10 shows a perspective view of a shutter of the window of FIG. 8;

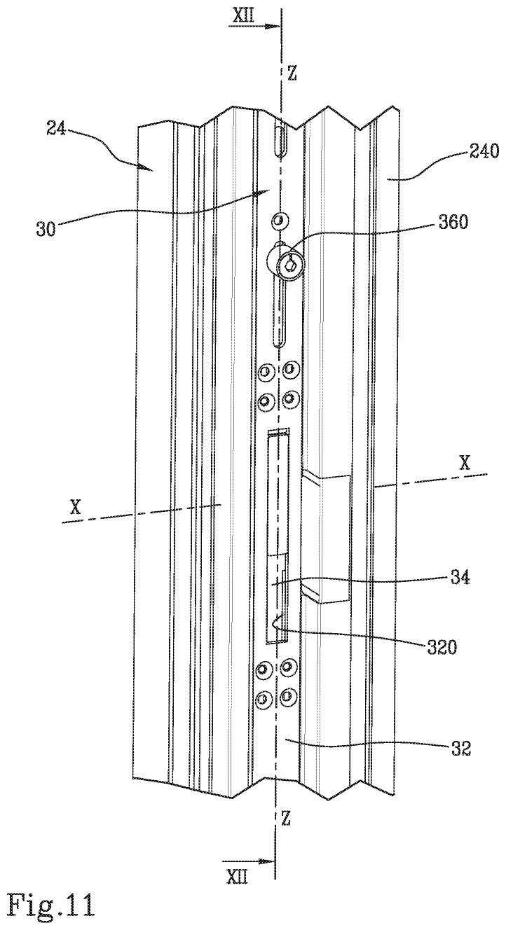

FIG. 11 shows an enlarged view of the detail referred to as XI in FIG. 10;

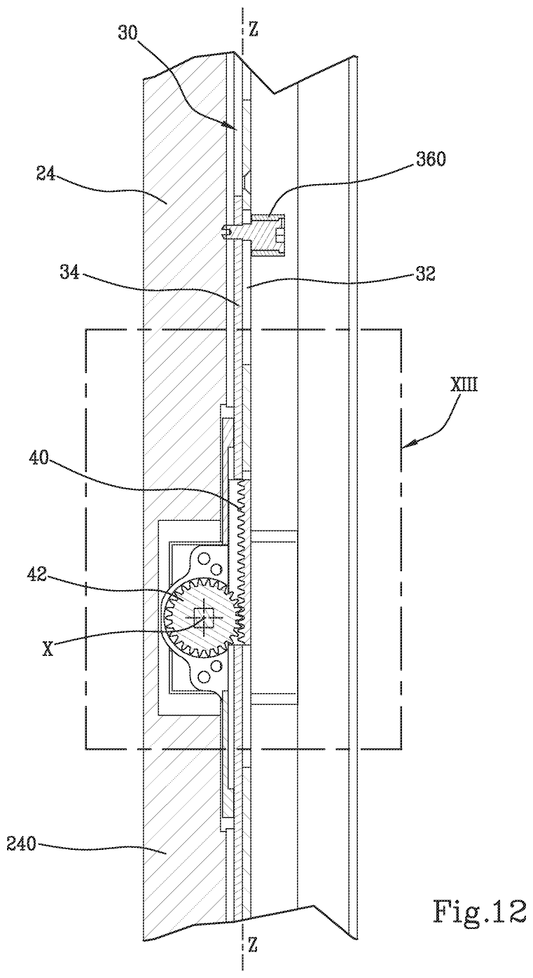

FIG. 12 shows a view of the cross section made along the plane XII-XII of FIG. 11;

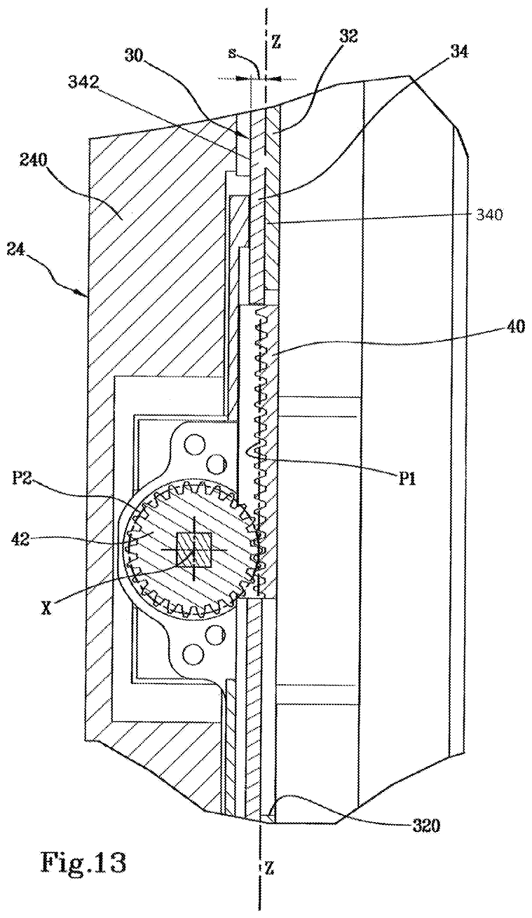

FIG. 13 shows an enlarged view of the detail referred to as XIII in FIG. 12;

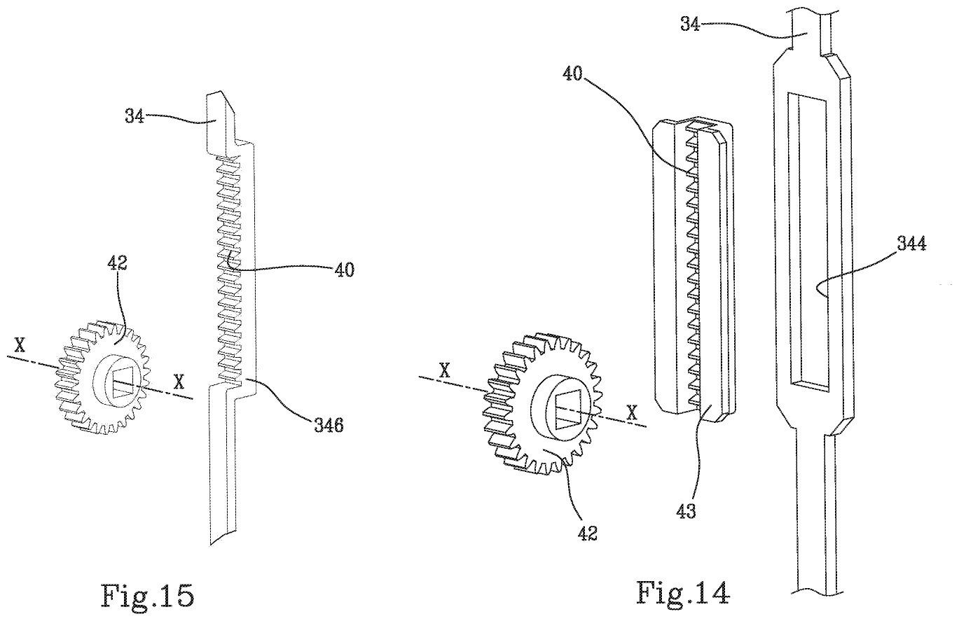

FIG. 14 shows an exploded perspective view of some metalware components according to a first embodiment of the invention;

FIG. 15 shows an exploded perspective view of some components of the metalware according to a comparative arrangement;

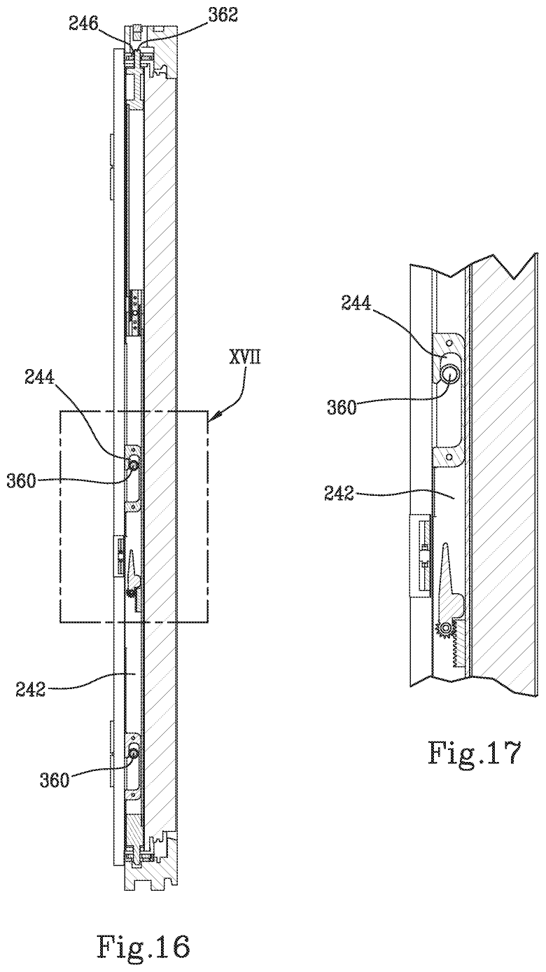

FIG. 16 shows a view of the cross section made along the plane XVI-XVI of FIG. 9; and

FIG. 17 shows an enlarged view of the detail referred to as XVII in FIG. 16.

Since the invention is intended to be used in presence of gravitational acceleration g, it is intended that the latter uniquely defines the vertical direction.

The present invention relates to a window 20 and the respective metalware 30. In a manner known per se, the window 20 comprises a fixed frame 22 and a movable frame 24 which can rotate around a hinge axis Y. Below reference will be made, in an exemplary and non-limiting manner, to the most common configuration of the window 20, in which the hinge axis Y is vertical. However, the skilled person will have no difficulty in reporting the teachings of the invention in a window 20 having a different configuration, for example in which the movable frame 24 rotates around a horizontal axis.

The metalware 30 is, in a manner known per se, the set of accessories, usually metallic, which are applied to the window to allow its opening and closing.

The metalware 30 according to the invention comprises:

a strip 32 suitable for being mounted in a fixed manner on a strut 240 of the window 20;

a rod 34 mounted slidingly with respect to the strip 32, wherein the rod 34 has:
an outer surface 340 facing the strip 32,
an inner surface 342, opposed to the outer surface 340, and
a thickness s spacing the outer surface 340 from the inner surface 342;

window locking members 36 of the window 20 mounted in a firm manner on the rod 34;

a rack 40 having a pitch surface p1 and mounted in a firm manner on the rod 34;

a pinion 42 having a pitch surface p2 and mounted on the strip 32 so that:
the pinion 42 can rotate around an axis X,
the pinion 42 engages the rack 40,
the axis X of the pinion 42 is fixed with respect to the strip 32,
the rod 34 is comprised between the strip 32 and the pinion 42.

In the metalware 30 according to the invention the pitch surface p1 of the rack 40 is spaced, with respect to the inner surface 342 of the rod 34, towards the strip 32 beyond the half thickness s of the rod 34; and

the rod 34 comprises a through aperture 344 inside which a canal-shaped structure 43 is inserted and the rack 40 is placed in the canal-shaped structure 43.

The fact that the pitch surface p1 of the rack 40 is spaced, with respect to the inner surface 342 of the rod 34, towards the strip 32, allows to employ a pinion 42 which, for the same overall size of the metalware 30, has a pitch diameter substantially greater than the pinion 42 of the prior art. As will be better described later, the greater dimensions of the pinion 42 imply significant technical advantages.

The rod 34, the strip 32 and therefore the entire metalware 30 share the same prevalent development direction Z, and the rod 34 is free to slide along the strip 32 in this direction Z The metalware configuration 30 defines the maximum stroke Sz which can be performed by the rack 40 (and therefore by the rod 34 and by the window locking members 36) along the Z direction. In particular, with the same overall dimensions, the maximum stroke Sz which can be obtained with the metalware 30 according to the invention is greater than the maximum stroke which can be obtained with a metalware 30 according to the prior art. The magnitude of the maximum stroke Sz is directly connected to the pitch diameter of the pinion 42, as well as to the rotation arc which it can perform during operation. However, as already said in relation to the prior art, the overall rotation of the pinion 42 is limited only to overall 180°, along which the three positions are to be distributed: closing, swing opening and fanlight opening. Therefore, the maximum stroke Sz is a function of only the pitch diameter of the pinion 42.

These technical features are better understood considering the attached figures. The representation of FIG. 7 is schematic and is aimed to understand some aspects of the invention, above all by comparison with FIG. 6 which shows a similar and equally schematic representation of the prior art. In particular, in FIGS. 6 and 7, for simplicity, the rack 40 and the pinion 42 have been represented without teeth, representing only their respective pitch surfaces p1 and p2.

As can be seen, in the known solution of FIG. 6, the pitch surface p1 of the rack 40 lies on the same plane as the inner surface 342 of the rod 34. As the skilled person can well understand, this simplified representation may be slightly different from some known solutions. In particular, in some known solutions the rack 40 can be made as a separate piece and then applied on the rod 34. In this case the pitch surface p1 of the rack 40 is slightly spaced, with respect to the inner surface 342 of the rod 34, towards the pinion 42, that is on the opposite side of the strip 32. In other solutions the rack 40 can instead be obtained by notching the teeth in the material of the rod 34 itself, for example by plastic deformation of the material or by machining. In this case, therefore, if the notch takes place from the inner surface 342 of the rod 34, it is clear that the pitch surface p1 of the rack 40 will be slightly spaced, with respect to the inner surface 342 of the rod 34, towards the strip 32. However, this displacement is not comparable with that of the invention.

FIG. 13 clearly shows how the pitch surface p1 of the rack 40 is spaced, with respect to the inner surface 342 of the rod 34, towards the strip 32 beyond the half thickness s of the rod 34.

According to some embodiments of the invention, the pitch surface p1 of the rack 40 is spaced, with respect to the inner surface 342 of the rod 34, beyond the outer surface 340 of the rod 34.

According to some embodiments of the invention, the strip 32 of the metalware 30 comprises a slot 320 at the rack 40. The slot 320 (which can be blind or through) allows to house the footprint of the rack 40 and/or the rod portion 34 on which the rack 40 is mounted.

With particular reference to FIGS. 14 and 15, some features of the invention are described below.

According to the invention, for example as shown in FIG. 14, the rod 34 comprises a through aperture 344 inside which a canal-shaped structure 43 is inserted and the rack 40 is placed in the canal-shaped structure 43.

According to other arrangements which are not part of the invention, for example that of FIG. 15, the rod 34 comprises a section 346 shifted with respect to the prevalent development of the rod 34 and the rack 40 is arranged on the shifted section 346. In particular, a rectilinear rod 34 can be subjected to successive bends in order to obtain the shape of FIG. 15. In all the described embodiments, the rack 40 can be made as a separate piece and then applied to the canal-shaped structure 43, or it can be obtained by notching the teeth in the material of the canal-shaped structure 43 itself.

In light of the foregoing, therefore, the slot 320 of the strip 32 houses slidingly the canal-shaped structure 43 of the rod 34. In particular, the length of the slot 320 allows the canal-shaped structure 43 to slide freely during the movement of the window locking members 36. In particular, the slot 320 develops in the prevalent development direction Z of the metalware 30, in order to allow the canal-shaped structure 43 to slide in this direction.

Preferably, the window locking members 36 comprise one or more locking pins 360 and/or one or more latches 362 mounted in a firm manner on the rod 34. In particular, the strip 32 comprises a slot at each locking pin 360. The locking pin 360 extends from the outer surface 340 of the rod 34 and goes through the respective slot of the strip 32 to extend in the opposite direction to the inner surface 342 of the rod 34. The latch 362, on the other hand, extends from the end of the rod 34, in the prevalent development direction Z of the metalware 30.

According to another aspect, the invention also relates to a window 20 comprising a fixed frame 22 and a frame 24 movable between a complete opening position and a complete closure position. The movable frame 24 comprises a strut 240 on which the metalware 30 is mounted according to the invention. The strut 240 must have transversal dimensions sufficient to house the entire metalware 30 inside, and in particular the pinion 42. As can be seen by comparing FIGS. 6 and 7, the metalware 30 according to the prior art and the metalware 30 according to the invention need respective struts having identical dimensions. However, as already underlined above, the strut 240 of the window according to the invention houses a metalware 30 with a pinion 42 of greater pitch diameter and which therefore allows a greater maximum stroke Sz for the window locking members 36.

Advantageously, the movable frame 24 can rotate around a hinge axis Y. The direction of the hinge axis Y is preferably parallel to the prevalent development direction Z of the metalware 30. Usually, both the hinge axis Y and the prevalent development direction Z of the metalware 30 are substantially vertical.

Preferably, the window 20 further comprises a handle 26 suitable for imposing a rotation around the axis X on the pinion 42. As can be seen in FIGS. 12 to 15, one way of connecting the handle 26 to the pinion 42 is to mount both of them on a bar suitable for transmitting the rotation, for example a square-cross section bar. However, as the skilled person can well understand, other kinematic connections can be employed for this purpose.

In a manner known per se, when the movable frame 24 is in the complete closure position, the strut 240 on which the metalware 30 is mounted matches to a matching structure 242. In an equally known manner, in the windows 20 with one shutter (such as the one represented schematically in FIGS. 1 and 3), the matching structure 242 is a strut of the fixed frame 22. Alternatively, in multi-shutter windows 20 (such as that represented schematically in FIGS. 2 and 4 or in FIGS. 8 and 9), the matching structure 242 is a strut of a second movable frame. Preferably, the second movable frame is locked with respect to the fixed frame 22, in order to remain firmly in position and to provide reliable abutment for the movable frame 24.

In a manner known per se, when the metalware 30 comprises one or more latches 362, the fixed frame preferably comprises as many hole seats 246, each of which is suitable for receiving a latch 362 which accesses it by sliding in the direction Z.

Similarly, when the metalware 30 comprises one or more locking pins 360, the matching structure 242 preferably comprises as many U-shaped seats 244, each of which is suitable for receiving a locking pin 360 which accesses it by sliding in the direction Z. For a secure closing of the window 20, each locking pin 360 must enter as far as possible into the groove of the respective U-shaped seat 244. The maximum dimension of the locking pins 360 is therefore limited by the maximum stroke Sz they can be imposed by the metalware 30. A locking pin 360 with a diameter greater than its own maximum stroke Sz could not enter sufficiently into the groove of the respective U-shaped seat 244 and would therefore not guarantee a secure closing of the window 20. The greater stroke Sz which, with the same dimensions of the strut 240, can be obtained with the metalware 30 of the invention thus allows greater dimensions for the locking pins 360 and therefore greater safety in closing.

As the skilled person can understand, the invention allows to overcome the drawbacks underlined above with reference to the prior art.

In particular, the present invention provides a metalware for a window which combines the need to maintain reduced dimensions for the strut of the movable frame and, at the same time, allows greater dimensions for the locking pins.

In this way, the window metalware allows to obtain locking pins with greater mechanical resistance and therefore to increase the level of safety. Furthermore, the present invention provides a metalware for a window which, alongside the advantages introduced with respect to known solutions, also maintains the benefits inherent in the latter.

It is clear that the specific features are described in relation to various embodiments of the invention with exemplifying and non-limiting intent. Obviously, a person skilled in the art may make further modifications and variations to this invention, in order to meet contingent and specific requirements. For example, the technical features described in connection with an embodiment of the invention may be extrapolated from it and applied to other embodiments of the invention. Such modifications and variations are, however, contained within the scope of the invention, as defined by the following claims.

1. (canceled)

2. Metalware according to claim 11, wherein the strip comprises a slot in correspondence of the rack.

3. (canceled)

4. (canceled)

5. (canceled)

6. (canceled)

7. (canceled)

8. (canceled)

9. (canceled)

10. (canceled)

11. Metalware for a window, comprising:
a strip suitable for being mounted in a fixed manner on a strut of the window;
a rod mounted in a sliding manner with respect to the strip, wherein the rod features an outer surface facing the strip, an inner surface, opposed to the outer surface, and a thickness s spacing the outer surface from the inner surface,
locking members of the window mounted on the rod;
a rack having a pitch surface p1 and mounted on the rod;
a pinion having a pitch surface p2 and mounted on the strip in such a manner that the pinion can rotate around an axis X, the pinion engages the rack, the axis X of the pinion is fixed with respect to the strip, and the rod is disposed between the strip and the pinion,
wherein the pitch surface p1 of the rack is spaced, with respect to the inner surface of the rod, towards the strip beyond the half thickness s of the rod, and wherein the rod comprises a through aperture inside which a canal-shaped structure is inserted and wherein the rack is placed in the canal-shaped structure.

12. Metalware according to claim 2, wherein the strip comprises a slot in correspondence of the rack where the slot of the strip slidingly houses the canal-shaped structure.

13. Metalware according to claim 11 wherein the rack is made as a separate piece and applied onto the canal-shaped structure.

14. Metalware according to claim 2 wherein the rack is made as a separate piece and applied onto the canal-shaped structure.

15. Metalware according to claim 11 wherein the strip comprises a slot in correspondence of the rack, the slot of the strip slidingly houses the canal-shaped structure, and the rack is made as a separate piece and applied onto the canal-shaped structure.

16. Metalware according to claim 11, wherein the pitch surface p1 of the rack is spaced, with respect to the inner surface of the rod, beyond the outer surface of the rod.

17. Metalware according to claim 2, wherein the pitch surface p1 of the rack is spaced, with respect to the inner surface of the rod, beyond the outer surface of the rod.

18. Metalware according to claim 15, wherein the pitch surface p1 of the rack is spaced, with respect to the inner surface of the rod, beyond the outer surface of the rod.

19. Metalware according to claim 11, wherein the locking members comprise at least one locking pin and at least one latch.

20. Metalware according to claim 15, wherein the locking members comprise at least one locking pin and at least one latch.

21. Metalware according to claim 18, wherein the locking members comprise at least one locking pin and at least one latch.

22. Metalware according to claim 11, further comprising a window including a fixed frame and a frame movable between a complete opening position and a complete closure position, wherein the metalware is mounted to a strut on the movable frame.

23. Metalware according to claim 21, further comprising a window including a fixed frame and a frame movable between a complete opening position and a complete closure position, wherein the metalware is mounted to a strut on the movable frame.

24. Metalware according to claim 23 further comprising a handle suitable for imposing to the pinion a rotation around the axis X.

25. A window, comprising:
metalware including; a) a strip suitable for being mounted in a fixed manner on a strut of the window, b) a rod mounted in a sliding manner with respect to the strip, wherein the rod features an outer surface facing the strip, an inner surface, opposed to the outer surface, and a thickness s spacing the outer surface from the inner surface, c) locking members of the window mounted on the rod, d) a rack having a pitch surface p1 and mounted on the rod, e) a pinion having a pitch surface p2 and mounted on the strip in such a manner that the pinion can rotate around an axis X, the pinion engages the rack, the axis X of the pinion is fixed with respect to the strip, and the rod is disposed between the strip and the pinion, e) wherein the pitch surface p1 of the rack is spaced, with respect to the inner surface of the rod, towards the strip beyond the half thickness s of the rod, and wherein the rod comprises a through aperture inside which a canal-shaped structure is inserted and wherein the rack is placed in the canal-shaped structure, and
a fixed frame and a frame movable between a complete opening position and a complete closure position, wherein the metalware is mounted to a strut on the movable frame.

26. The window according to claim 25, further comprising at least one locking pin, at least one latch and at least one hole seat disposed on the fixed frame wherein when the movable frame is in the complete closure position, the strut matches at least one U-shaped seat adapted to receive the locking pin.

27. The window according to claim 25, wherein the metalware further comprises at least one locking pin, wherein, when the movable frame is in the complete closure position, the strut matches a matching structure, and wherein the matching structure comprises at least one U-shaped seat suitable for receiving the locking pin of the metalware.

28. The window according to claim 25, wherein the metalware further comprises at least one latch, wherein, when the movable frame is in the complete closure position, the strut matches the fixed frame, and wherein the fixed frame comprises at least one hole seat suitable for receiving the latch of the metalware.

29. The window according to claim 25, wherein the metalware further comprises at least one locking pin and at least one latch, wherein:
when the movable frame is in the complete closure position, the strut matches a matching structure, and wherein the matching structure comprises at least one U-shaped seat suitable for receiving the locking pin of the metalware; and
when the movable frame is in the complete closure position, the strut matches the fixed frame, and wherein the fixed frame comprises at least one hole seat suitable for receiving the latch of the metalware.
